(19) United States
(12) Patent Application Publication
(10) Pub. No.: US 2005/0228150 A1
(43) Pub. Date: Oct. 13, 2005

(54) Use of instantaneous split to improve reactor control

(75) Inventors: John R. Parrish, Charleston, WV (US); William H. Sachs, Princeton, NJ (US); Ivan J. Hartley, Victoria, TX (US); Paul K. Samples, Scott Depot, WV (US)

Correspondence Address: BAKER & MCKENZIE LLP, 711 LOUISIANA, SUITE 3400, HOUSTON, TX, 77002-2716, US

(73) Assignee: UNION CARBIDE CHEMICALS & PLASTICS TECHNOLOGY CORPORATION, Danbury, CT (US)

(21) Appl. No.: 11/105,066

(22) Filed: Apr. 13, 2005

Related U.S. Application Data
(60) Provisional application No. 60/561,861, filed on Apr. 13, 2004.

(51) Int. Cl. C08F 2/00

(52) U.S. Cl. 526/60; 526/114; 526/59

(57) ABSTRACT

A method of manufacturing a polymer composition that includes initiating a polymerization reaction at an initial set of polymerization parameters, determining an instantaneous split of the at least one property of an intermediate polymer composition, and adjusting the initial set of polymerization parameters based on the instantaneous split of the at least one property to obtain a desired distribution of the at least one property in the polymer composition.

### CROSS REFERENCE TO RELATED APPLICATIONS

This Application claims priority to prior filed U.S. Provisional Application Ser. No. 60/561,861 filed on Apr. 13, 2004, which is incorporated herein in its entirety.

### FEDERALLY SPONSORED RESEARCH

Not Applicable.

### REFERENCE TO MICROFICHE APPENDIX

Not Applicable.

### FIELD OF THE INVENTION

This invention relates to the manufacture of polyolefin resins, and in particular to the manufacture of polyolefin resins having polymodal, especially bimodal, molecular weight, density, or other characteristics.

### BACKGROUND OF THE INVENTION

Multi-modal, multivariative molecular weight and chemical composition distributions have become increasingly important product design features for high performance polyolefin resins. Mixed-catalyst systems represent a major advance in meeting the requirements for such polyolefin resins, in part because mixed catalyst systems have lower capital investment costs. But product consistency and reactor performance could be improved in these systems.

Bimodal resins may be made in two separate reactors or reaction chambers. In the case of bimodal molecular weight distribution products, a product having a first molecular weight is moved directly from the first reaction zone where it is made to a second reaction zone having conditions for making a resin of a different molecular weight, where more resin is made. The resins are mixed in the second reactor while the second resin is being made. In some cases, the two resins are even present in the same particle. But two-stage processes are naturally more complex to control and are more expensive to construct because two reactors, or at least two reaction zones with precision control infrastructure are required. In addition, because the products are made in separate reactors, the resulting composition may contain at least some particles that consist of only one of the resins from the first or second reactor. The physical properties of compositions with particles containing only one resin are often undesirable.

Besides reducing capital costs and improving resin homogeneity, mixed catalyst systems also allow the composition of the polymer product to be tailored in a variety of ways. One way to tailor the composition is to select catalysts according to their effect on the structural characteristics, such as nature and degree of branching, of the polymers they generate. Catalyst selection can also affect particle morphology. The relative amount of the components in a bimodal product, or of particular components in multimodal compositions, is another useful property that can be controlled by selection of proper catalysts. Thus, polymerization processes that can effectively employ mixed catalyst technology offer many advantages over staged reactor systems.

As mentioned above, the relative ratio of the components in a resin is one area where mixed catalysts provide an advantage. In a mixed catalyst system, the relative amount of each polymer component is primarily a function of the relative amount and activity of each of the catalysts in the catalyst system. Theoretically, a catalyst system containing proper amounts of each catalyst could be generated and used to produce the desired split for a particular end composition. But such systems are difficult to control because the relative productivities of the catalyst components change over the course of the polymerization process. For instance, each of the catalysts in a mixed catalyst system typically has a different sensitivity to variations in reactor conditions or poison levels. Small fluctuations in the relative feed rates of each catalyst can also affect the split of the resulting composition. But to obtain a resin with the desired properties, it is important to precisely control the relative amounts of the components. For instance, in the manufacture of certain products it is necessary to control these amounts to within about 1-2% of the target value.

While the relative ratio is an important feature of the overall polymer composition, controlling and measuring this ratio in typical polymerization processes is complicated by several factors. Multiple reaction zones and lack of intermediate sampling points are two such difficulties. So it can be difficult to effectively and efficiently control the process in a way that yields a desired polymer product. Also, the split of a polymer composition being produced at any given time varies in response to changes in various process conditions. But the changes to the overall or cumulative split due to these same process variations occurs with a large time constant under typical reaction conditions. Consequently, by the time a change in the cumulative split is detected in polymer sampled at the reactor outlet, the process cannot be adjusted to correct the split to the desired value.

For one or more of the above reasons, there is a need in the art for improved polymerization processes.

### SUMMARY OF THE INVENTION

A method of manufacturing a polymer composition is described that includes initiating a polymerization reaction at an initial set of polymerization parameters, periodically determining an instantaneous split of the at least one property of an intermediate polymer composition, and periodically adjusting the initial set of polymerization parameters based on the instantaneous split of the at least one property to obtain a desired split of the at least one property in the polymer composition.

The polymerization may be initiated by any suitable means. In some embodiments, the polymerization is initiated by providing at least one catalyst. In some embodiments, the polymerization is initiated by at least one multi-modal catalyst system. Ziegler Natta catalysts are one example of suitable multi-modal catalyst systems, although any multi-modal catalyst or catalyst system may be used. In some embodiments, the catalyst system is a bimodal catalyst system. Some bimodal catalyst systems include a Ziegler Natta catalyst. Some embodiments use a catalyst system that includes a Ziegler Natta catalyst and a metallocene catalyst. In some embodiments, a metallocene catalyst system is used. Where the catalyst system is a metallocene based catalyst system, a combination of catalysts may be used. In some embodiments, the metallocene catalyst is a dual site metallocene catalyst. In some embodiments, the metallocene catalyst system produces a low molecular weight component of the polymer composition. Some processes have a high molecular weight component that is prepared by a metallocene catalyst.

The process described herein may be any type of polymerization process. In some embodiments, the process is a single reactor process. In other embodiments, the process is a series or parallel multi-reactor process. In those embodiments that have more than one reactor, the methods described herein may be applied to one or more of the reactors in the process. The method may be a solution, slurry or gas-phase polymerization process.

The methods described herein may be applied to a variety of processes and polymer compositions. In some embodiments, the method relates to a process for making a bimodal polymer composition. The method of claim 1, wherein the polymer composition is an ethylene or propylene homopolymer or alpha-olefin copolymer composition. In some embodiments, the process is a process for making an elastomer composition.

The instantaneous split can be associated with a variety of properties in the methods describe herein. In some embodiments, the instantaneous split is the ratio of the weight of a first polymer component to the weight of a second polymer component. In other embodiments, the split is the ratio of the density of a first polymer component to the density of a second polymer component. The split may also be a ratio of a long chain branching content of a first polymer component to the long chain branching content of a second polymer component. Any property that can be correlated to the incorporation rate and/or effective activity of the catalyst can be modelled.

In some embodiments of the process, determining the instantaneous split of the composition in the reactor includes updating a distribution model based on one or more scalar properties of the intermediate polymer composition. Suitable scalar properties include, but are not limited to, melt index, flow index, melt flow ratio, density, or other Theological property.

The methods described herein for controlling a polymerization reaction may be applied to any polymerization parameter. In some cases, adjusting a polymerization reaction parameter includes controlling the concentration of a catalyst deactivating agent. In some embodiments, adjusting a polymerization reaction parameter includes controlling the amount of a chain transfer agent. The temperature and pressure of the process may also be controlled in order to effect the products of the reaction.

In some embodiments, the method further includes comparing the split to a reference split. Some embodiments also include minimizing the difference between the split and the reference split. Any method can be used to minimize the difference between the instantaneous split and the reference split. In some embodiments, a least squares method is used to minimize the difference between the instantaneous split and the reference split.

In some embodiments, the process further includes determining a scalar property and wherein adjusting the split includes adjusting the scalar property. Some examples of scalar properties of the polymer composition or of individual components of the polymer composition include a melt index, a flow index, a melt flow ratio, density, or any other rheological property.

In other embodiments, a method controlling the polymodal split of a polymerization process is described that includes conducting the polymerization process in the presence of at least one polyselective catalyst composition, determining at least one process condition, estimating the polymodal split from the process conditions, and adjusting the process conditions to obtain a desired polymodal split. Some exemplary process conditions that can be adjusted include the reaction temperature, reaction pressure, monomer partial pressure, bed weight, catalyst feedrates, and the concentration of catalyst promoters or catalyst retarding agents.

Some embodiments provide for a method of manufacturing a polymer composition that includes determining an instantaneous split of at least one property of an intermediate polymer composition, determining a target split of the polymer composition, and adding a polymer component to the intermediate polymer composition, wherein the amount of the polymer component is determined by minimizing the difference between the distribution of the at least one property of the intermediate polymer composition and the target split of the at least one property of the polymer composition.

The description also provides a method of manufacturing a polymer composition that includes initiating a polymerization reaction at an initial set of polymerization parameters, determining a polymer split from an instantaneous distribution of an intermediate polymer composition, and adjusting the initial set of polymerization parameters based on the polymer split to obtain a desired split in the polymer composition.

### BRIEF DESCRIPTION OF THE DRAWINGS

FIG. 1 shows the results of applying one embodiment of the method for modelling and controlling the split of a polymerization process and compares the portion of HMW product in a polymerization reaction as predicted by embodiments for modeling the instantaneous split, the cumulative split and experimentally measured split over the course of a polymerization reaction.

### DESCRIPTION OF EMBODIMENTS OF THE INVENTION

In the following description, all numbers disclosed herein are approximate values, regardless whether the word “about” or “approximately” is used in connection therewith. They may vary by up to 1%, 2%, 5%, or sometimes 10 to 20%. Whenever a numerical range with a lower limit, R_{L}, and an upper limit R_{U}, is disclosed, any number R falling within the range is specifically disclosed. In particular, the following numbers R within the range are specifically disclosed: R=R_{L}+k*(R_{U}−R_{L}), where k is a variable ranging from 1% to 100% with a 1% increment (i.e., k is 1%, 2%, 3%, 4%, 5%, . . . , 50%, 51%, 52%, . . . , 95%, 96%, 97%, 98%, 99%, or 100%). Moreover, any numerical range defined by two numbers, R, as defined above is also specifically disclosed.

All references herein to elements or metals belonging to a certain Group refer to the Periodic Table of the Elements published and copyrighted by CRC Press, Inc., 1999. Also any reference to the Group or Groups shall be to the Group or Groups as reflected in this Periodic Table of the Elements using the IUPAC system for numbering groups. As used herein, the term “comprising” is not intended to exclude any additional component, additive or step. For purposes of United States patent practice, the contents of any patent, patent application, or publication referenced herein are hereby incorporated by reference in their entirety, especially with respect to the disclosure of synthetic techniques and general knowledge in the art.

As used herein, the term “multimodal” means that a polyolefin resin has two or more distinct ranges of molecular weight, density, comonomer content distribution, or long chain branching distribution. The term “bimodal,” as used herein, means that the molecular weight distribution (MWD) in a GPC curve exhibits two component polymers, wherein one component polymer may even exist as a hump, shoulder or tail relative to the MWD of the other component polymer. Of course, in some embodiments, a “bimodal molecular weight distribution” may be deconvoluted with the freedom to fit more than two peaks. In some embodiments, the term “bimodal” does not include multimodal polymers, such as LDPE.

The term “split,” as used herein, means the fraction of an overall polymer component having a desired property. The desired property may be a molecular weight, comonomer content distribution, or long chain branching distribution density, or any other useful property. For example, the term “split” may refer to the weight fraction of a low molecular weight (LMW) component in a bimodal composition. Or the term “split” may refer to the amount of a relatively low density component in a composition with components of other densities. Or the term “split” may refer to that portion of the composition with a desirable amount of long chain branching.

A method of manufacturing a polymer composition is described herein. This method includes initiating a polymerization reaction at an initial set of polymerization parameters, determining an instantaneous split of the at least one property of an intermediate polymer composition, and adjusting the initial set of polymerization parameters based on the instantaneous split of the at least one property to obtain a desired split of the at least one property in the polymer composition.

In some embodiments, the method is a well-mixed continuous polymerization process using a binary catalyst system. The description below describes the time dependence of the polymer split and how it can be used to control the properties of a polymer composition in such a polymerization system. By determining and manipulating the instantaneous split, S, the steady-state value of the cumulative split, S_{c}, may be controlled. But the instantaneous split cannot be measured. So it is inferred from models for the process in combination with suitable kinetic models for the catalyst system. Any suitable model for the split may be used. One such model is described in U.S. Provisional Application Ser. No. 60/471,269 filed on May 16, 2003.

In some embodiments, the models employ the “method of moments” and a simple kinetic model for a binary catalyst system. The model includes a system of ordinary differential equations describing the rate of change in the inventory of active catalyst of each type in the reactor bed, together with one or more algebraic equations for the mass production rates for each catalyst component, and equations for cumulative and instantaneous split. The model facilitates the estimation of these parameters from readily available process measurements and a small number of basic kinetic parameters for each catalyst component. Kinetic parameters for catalyst components can be predetermined or estimated from laboratory and pilot-scale kinetic studies. In some embodiments, the kinetic parameters may be obtained by process measurements during routine commercial operation. For some purposes, the method of moments approach may be too restrictive to be conveniently employed. In such cases, the expressions described herein may be simplified by appropriate parameterization. In other embodiments, the method of moments may be made more rigorous by relaxing certain assumptions. In those embodiments, a more comprehensive model for production rate and split may be used at the expense of simplicity.

Some embodiments employ a model that relates the production rate of the HMW component P_{R}^{HMW} to the variable Z^{HMW} as a function of the reactor total pressure, P; the mole fraction of the each monomer, Xₙ; and model parameters, Kᵢ, that relate to the catalyst propagation rate constants. For the case of two monomers in a copolymerization reaction, the relationships are
P_{R}^{HMW}=PZ^{HMW}[X₁K₁+X₂K₂] (1)
P_{R}^{LMW}=PZ^{LMW}[X₁K₃+X₂K₄] (2)
In equations (1) and (2) These two relationships are used to model the split of the HMW component since the split is related to the production rates of each of the components. Thus, the split is given by:

$$S = \frac{{Z}^{HMW} [ {X}_{1} {K}_{1} + {X}_{2} {K}_{2} ]}{{Z}^{HMW} [ {X}_{1} {K}_{1} + {X}_{2} {K}_{2} ] + {Z}^{LMW} [ {X}_{1} {K}_{3} + {X}_{2} {K}_{4} ]} \qquad ( 3 )$$

In other embodiments, equation 14 is restructured to give a model of monomer incorporation. For a two monomer polymerization, the monomer incorporation models can be written
I₁=PX₁[K₁Z^{HMW}+K₃Z^{LMW}] (4)
I₂=PX₂[K₂Z^{HMW}+K₄Z^{LMW}] (5)
in embodiments employing this type model the production rate is the sum of the incorporation rates for each monomer. Thus, both split and comonomer incorporation may be modeled with more easily obtainable process data. For instance, K₁ and K₃ may be estimated from studies on the incorporation kinetics of monomer 1 with the HMW and LMW catalysts, respectively. Likewise, the parameters K₂ and K₄ are determined or estimated from studies of the incorporation rates of monomer 2 with the same catalysts. In some embodiments, reactor heat and mass balance methods are used to estimate the monomer incorporation values. This allows process to be modeled in terms of decoupled equations based on the Kᵢ values, which are available from production rate data. The values are expected to be fairly constant over the course of the reaction. Thus, changes in the incorporation rate over the course of the polymerization process are linked to the value of the Z-variable for each catalyst. In the case of a bimodal process, the incorporation rates are linked to Z^{HMW} and Z^{LMW}.

In some embodiments employing incorporation rates, the model is applied using one or more process parameters. Suitable process conditions include reaction temperature, reaction pressure, monomer partial pressure, bed weight, catalyst feedrates and the concentration of catalyst promoters or catalyst retarding agents. These parameters are used to calculate the total production rate, instantaneous monomer incorporation rates, and the instantaneous split.

In some embodiments, the Kᵢ values are determined by a least squares method. In some embodiments, the Kᵢ values are estimated using the following vector-matrix relationships:

$$[ \begin{matrix}{K}_{1} \\ {K}_{3}\end{matrix} ] = {[ {Y}^{T} Y ]}^{- 1} {Y}^{T} A and [ \begin{matrix}{K}_{2} \\ {K}_{4}\end{matrix} ] = {[ {Y}^{T} Y ]}^{- 1} {Y}^{T} B$$

where Y is an array of the Z values for the catalysts, and A and B are related to the comonomer incorporation values for the respective comonmers,

$$Y = [ \begin{matrix}{Z}_{1}^{HMW} & {Z}_{1}^{LMW} \\ {Z}_{2}^{HMW} & {Z}_{2}^{LMW} \\ … & … \\ {Z}_{n}^{HMW} & {Z}_{n}^{LMW}\end{matrix} ] ;$$

$$A = [ \begin{matrix}{( {I}_{1} / {PX}_{1} )}_{1} \\ {( {I}_{1} / {PX}_{1} )}_{2} \\ … \\ {( {I}_{1} / {PX}_{1} )}_{n}\end{matrix} ] ; and$$

$$B = [ \begin{matrix}{( {I}_{2} / {PX}_{2} )}_{1} \\ {( {I}_{2} / {PX}_{2} )}_{2} \\ … \\ {( {I}_{2} / {PX}_{2} )}_{n}\end{matrix} ]$$

in these arrays, n is the number of samples used for the analysis and the individual entries 1,2, . . . , n are the sample number ordered in time from 1 to n.

In other embodiments, more rigorous models may be used. For example, if the catalyst is not preactivated, the catalyst induction period or activation time may need to be accommodated in the model of equation. In some embodiments, the model of the reaction system accounts for the fraction of free catalyst sites, especially where the fraction of free active catalyst sites in the reactor is small in comparison with the fraction of active catalyst sites attached to growing chains. Another factor that may be considered, is the relative rate of disappearance of live polymer through chain transfer with respect to the rate of reappearance of live polymer following chain re-initiation. In some processes, the rates of the disappearance and reappearance of live polymer chains may be relatively long compared with other kinetic effects described herein and may be accounted for with experimentally determined parameters. Factors for non-isothermal processes can be incorporated where appropriate. In such embodiments, the temperature dependence of rate constants may be incorporated using either Arrhenius equations or the more fundamental equations from Absolute Rate Theory. Some other factors that may be considered by the model include propagation rates that depend on the identity of the last inserted monomer, comonomer “mis-insertion” effects, conomoner “boost” effects, hydrogen poisoning. The method described herein can also be used for processes that are not first order with respect to monomer reaction. Parameters may be developed to account for non-first order reactions by those skilled in the art.

Other factors include kinetic effects such as the productivity or activity enhancing effects of conomoner, variable monomer reaction orders, the productivity modifying effects of hydrogen, and the effects of cocatalyst or other chemical agents that may be used inline to modify catalyst behavior. The potential for interaction between component catalysts should also be considered. These factors are discussed in “Polymerization of Olefins Through Heterogeneous Catalysis. XVIII. A Kinetic Explanation for Unusual Effects”, by W. K. A. Shaffer et al. J. Appl. Polym. Sci., 65, 1053-1080 (1997), the disclosure of which is incorporated by reference herein in its entirety.

Some catalyst systems used in embodiments of the processes described herein may exhibit behavior that is characteristic of a catalyst with more than one active site. Ziegler-Natta catalysts are typically multi-site catalysts. But because the model described above is directed at a mixed-catalyst system, it serves as a basic model for extension to more complex systems. The resulting experimental and parameter estimation are discussed in “Ethylene Polymerization Reactions with Zigler-Natta Catalysts. I. Ethylene Polymerization Kinetics and Kinetic Mechanism”, by Y. V. Kissen, et al., J. Polym. Sci., Polym. Chem. 37, 4255-4272 (1999); “Statistical Issues in Kinetic Modelling of Gas-Phase Ethylene Compolymerization”, by B. M. Shaw, Ph.D. Thesis, Department of Chemical Engineering, Queens University, (1999); “Reaction Modeling for Olefin Polymerization”, by C. Cozewith, Kenote Lecture, 1st European Conference on the Reaction Engineering of Polyolefins, Lyon, France, Jul. 3-6, 2000; and “Estimating Kinetic Parameters in Multi-Site Models for Ethylene Polymerization using Semi-Batch Reactor Data: What Can be Done when there are so Many Parameters?” by McAuley, et al, Oral Presentation, 1st European Conference on the Reaction Engineering of Polyolefins, Lyon, France, Jul. 3-6, 2000, the disclosures of which are incorporated herein by reference in their entirety.

Some processes may be affected by particle, thermodynamic, or transport effects. The homogeneous process and kinetic models described above do not explicitly account for the heterogeneous nature of gas-phase polymerization processes. In some processes, the model may include parameters that account for monomer solubility and diffusion resistance in growing particles in order to simulate the effect of monomer and comonomer concentrations in the vicinity of active catalyst sites as discussed in “Polymerization of Olefins through Heterogeneous Catalysis. VIII. Monomer Sorption Effects”, by R. A. Hutchinson et al, J. Appl. Polym. Sci., 41, 51-81 1990, the disclosure of which is incorporated herein in its entirety. Highly active catalysts and particle volume growth can affect the kinetics of second-order reactions between species and should be considered where appropriate. Other models for polymer particle growth models are disclosed in “Reactor residence-time distribution effects on the multistage polymerization of olefins—I. Basic principles and illustrative examples, polypropylene”, by Zacca et al., Chem. Eng. Sci., 51, 4859-4886 1996; “Reactor residence-time distribution effects on the multistage polymerization of olefins—III. Polymer properties: bimodal polypropylene and linear low-density polyethylene”, by Zacca et al, Chem. Eng. Sci., 52, 1941-1967, 1997; “Reactor residence-time distribution effects on the multistage polymerization of olefins—III. Multilayered products: impact polypropylene”, by Debling, et al, Chem. Eng. Sci., 52, 1969-2001 1997; and “Recent Developments in Modeling Gas Phase Olefin Polymerization Fluidized Bed Reactors: From Microscale to Macroscale”, by Yiagopoulos, et al, Oral Presentation, 1st European Conference on the Reaction Engineering of Polyolefins, Lyon, France, Jul. 3-6, 2000, the disclosures of which are incorporated herein in its entirety. And any such model may be incorporated into the models for the polymerization processes described above.

Other perturbations that may occur in polymer processes may be accommodated by empirical parameterization. For example, changes in feed stream purity and batch-to-batch catalyst variability are common fluctuations in process parameters that can be monitored and accounted for by adaptively re-estimating selected model parameters when model predictions begin to depart significantly from laboratory or online measurements of any measurable process parameter, especially split and total production rate.

Polymerization reactions are typically conducted by contacting a stream of ethylene, in a gas phase process, such as in the fluid bed process described below, and substantially in the absence of catalyst poisons such as moisture, oxygen, CO, CO₂, and acetylene with a catalytically effective amount of the catalyst at a temperature and at a pressure sufficient to initiate the polymerization reaction. In general, the reaction may be performed at any conditions suitable for the selected catalyst and may be conducted under slurry or gas phase conditions. Embodiments of the process are suitable for the polymerization of C₂-C₆ olefins including homopolymers and copolymers of ethylene with α-olefins such as, but not limited to, 1-butene, 1-hexene, 4-methyl 1-pentene, and 1-octene. In some embodiments, the process is used to make polypropylene homopolymer or polypropylene copolymers. In some embodiments, the processes described herein can also be applied to the production of elastomeric compositions.

In some embodiments, the models described above are used in a gas-phase polymerization reactor. In a continuous gas phase process, one or more partially or completely activated catalyst compositions are continuously fed to the reactor. Discrete portions of any activator compound needed to complete the catalyst composition may be added during the continuing polymerization process in order to replace active catalyst sites that are expended during the course of the reaction. In some embodiments, the discrete portions of activator may adjusted in order to affect the split. A fluidized bed reaction system can be used in gas phase polymerization. Fluid bed reaction systems are discussed in detail in U.S. Pat. Nos. 4,302,565 and 4,379,759 which are incorporated herein by reference in their entirety.

### EXAMPLES

While the example below uses a least squares method to fit the model parameters, any parameter fitting model may be used. Likewise, any method may be used to determine if control action is necessary when the modeled split is not within tolerance.

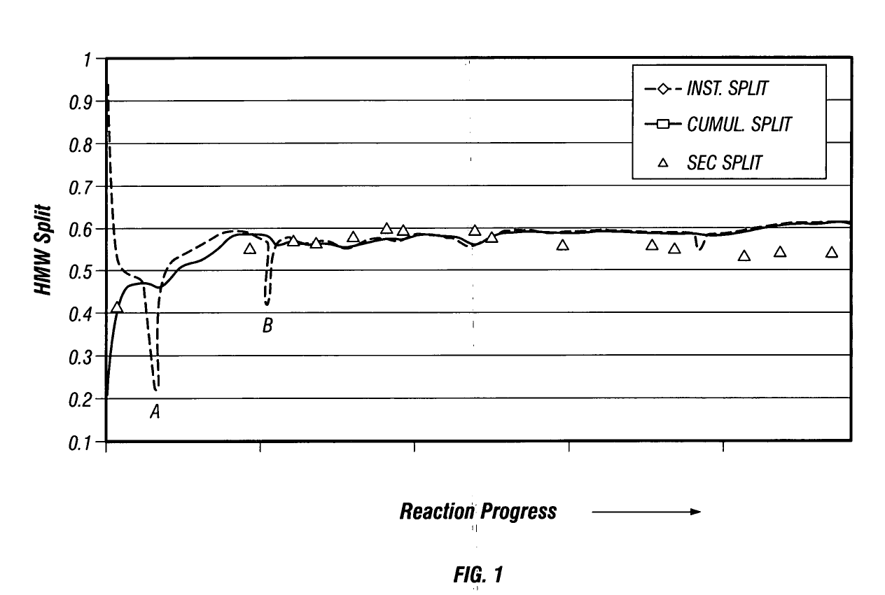

A gas-phase polymerization reaction designed to produce a bimodal ethylene/hexene copolymer with a split of 0.6 HMW fraction was initiated and modeled with an embodiment of the process described herein. The model was applied to calculate the instantaneous split and cumulative split at regular intervals over the course of the reaction. FIG. 1 illustrates the estimated instantaneous split, as well as the calculated cumulative split and split as measured by Size Exclusion Chromatography (SEC) during the reaction. At point A, the instantaneous split indicates that too little HMW fraction is being produced. Yet, FIG. 1 also illustrates that neither the cumulative split nor the split measured by SEC reflect the severity of the deviation. In this embodiment, the catalyst feedrates were adjusted to provide more HMW product. At point B in the reaction, application of the method described herein estimated that instantaneous split of HMW product is lower than desired. Again, catalyst feedrates to increase the amount of HMW product were calculated and applied to maintain the overall split within tolerance. While catalyst feedrates were adjusted in this example, the choice was merely one of convenience. Another parameter, such as reactor temperature, comonomer concentration, or other reaction parameter-could have been-adjusted.

While the invention has been described with a limited number of embodiments, these specific embodiments are not intended to limit the scope of the invention as otherwise described and claimed herein. Moreover, variations and modifications therefrom exist. It should be recognized that the process described herein may be used to make polymers which incorporate one or more additional comonomers. The incorporation of additional comonomers may result in beneficial properties which are not available to homopolymers or copolymers and parameters for modeling instantaneous and cumulative distributions should be adjusted to account such comonomers. While the processes are described as comprising one or more steps, it should be understood that these steps may be practiced in any order or sequence unless otherwise indicated. These steps may be combined or separated. Finally, any number disclosed herein should be construed to mean approximate, regardless of whether the word “about” or “approximate” is used in describing the number. The appended claims intend to cover all such variations and modifications as falling within the scope of the invention.

1. A method of manufacturing a polymer composition, comprising:
(a) initiating a polymerization reaction at an initial set of polymerization parameters;
(b) periodically determining an instantaneous split of the at least one property of an intermediate polymer composition; and
(c) periodically adjusting the initial set of polymerization parameters based on the instantaneous split of the at least one property to obtain a desired split of the at least one property in the polymer composition.

2. The method of claim 1, wherein the instantaneous split is estimated using the formula:
$$S = \frac{{Z}^{HMW} [ {X}_{1} {K}_{1} + {X}_{2} {K}_{2} ]}{{Z}^{HMW} [ {X}_{1} {K}_{1} + {X}_{2} {K}_{2} ] + {Z}^{LMW} [ {X}_{1} {K}_{3} + {X}_{2} {K}_{4} ]}$$
X₁ is the mole fraction of a first comonomer, X₂ is the mole fraction of comonomer 2, K₁ is the catalyst propagation rate constant for a first catalyst of the system, K₂ is a second catalyst propagation rate constant; K₃ is a third catalyst propagation rate constant, K₄ is a fourth catalyst propagation rate constant, Z^{HMW} is the product of the HMW catalyst productivity and catalyst feed rate, and Z^{LMW} is the product of the LMW catalyst productivity and catalyst feed rate

3. The method of claim 1, further including comparing the split to a reference split.

4. The method of claim 3, further including minimizing the difference between the split and the reference split by manipulation of a reactor variable.

5. The method of claim 4, wherein minimizing is accomplished by a least squares method.

6. The method of claim 1, wherein the polymer composition is a bimodal polymer composition.

7. The method of claim 1, wherein the polymer composition is an ethylene or propylene homopolymer or alpha-olefin copolymer composition.

8. The method of claim 1, wherein the split is the ratio of the weight of a first polymer component to the sum of the weights of the first and second polymer components.

9. The method of claim 1, wherein the split is a ratio of a long chain branching content of a first polymer component to the long chain branching content of a total polymer component.

10. The method of claim 1, wherein determining the instantaneous split includes updating a distribution model based on one or more scalar properties of the intermediate polymer composition.

11. The method of claim 10, wherein the scalar properties include melt index, flow index, melt flow ratio, density, or other rheological property.

12. The method of claim 1, wherein the adjusting a polymerization reaction parameter includes controlling the concentration of a catalyst deactivating agent.

13. The method of claim 1, wherein adjusting a polymerization reaction parameter includes controlling the concentration of a chain transfer agent.

14. The method of claim 1, wherein initiating the polymerization reaction includes providing at least one catalyst.

15. The method of claim 1, wherein initiating the polymerization reaction includes providing at least one multimodal catalyst system.

16. The method of claim 15, wherein the multimodal catalyst system is a bimodal catalyst system that includes a Ziegler-Natta catalyst.

17. The method of claim 1, wherein the multimodal catalyst system is a bimodal catalyst system that includes at least one Ziegler-Natta catalyst and at least one metallocene catalyst.

18. The method of claim 1, wherein the multimodal catalyst system is a bimodal catalyst system that includes a low molecular weight metallocene catalyst and a high molecular weight catalyst.

19. The method of claim 1, wherein the multimodal catalyst system is a bimodal catalyst system that includes a dual site catalyst system.

20. The method of claim 1, wherein the method is a series or parallel multi-reactor process.

21. The method of claim 1, further including determining a scalar property and wherein adjusting the split includes adjusting the scalar property.

22. The method of claim 21, wherein the scalar property is selected from the group consisting of a melt index, a flow index, a melt flow ratio, density, and any other rheological property.

23. A method of controlling the polymodal split of a polymerization process, comprising the periodic steps;
(a) conducting said polymerization process in the presence of at least one polyselective catalyst composition;
(b) determining at least one process condition;
(c) estimating the polymodal split from the process conditions;
(d) adjusting the process conditions to obtain a desired polymodal split.

24. The method of claim 23, wherein the process conditions include catalyst feedrates and the concentration of catalyst promoters or catalyst retarding agents.

25. A method of manufacturing a polymer composition comprising:
(a) determining an instantaneous split of at least one property of an intermediate polymer composition;
(b) determining a target split of the polymer composition;
(c) adding a polymer component to the intermediate polymer composition, wherein the amount of the polymer component is determined by minimizing the difference between the distribution of the at least one property of the intermediate polymer composition and the target split of the at least one property of the polymer composition.

26. A method of manufacturing a polymer composition, comprising periodically:
(a) initiating a polymerization reaction at an initial set of polymerization parameters;
(b) determining a polymer split;
(c) adjusting the initial set of polymerization parameters based on the polymer split to obtain a desired split in the polymer composition.

27. A method of manufacturing a polymer composition, comprising:
(a) periodically determining effective catalyst activity (Zi), gas composition (Xi), and apparent comonomer incorporation (Ii) rates.
(b) optionally periodically determining Ki, for i=1,2,3,4
(c) periodically determining a polymer split according to the following equation:
$$S = \frac{{Z}^{HMW} [ {X}_{1} {K}_{1} + {X}_{2} {K}_{2} ]}{{Z}^{HMW} [ {X}_{1} {K}_{1} + {X}_{2} {K}_{2} ] + {Z}^{LMW} [ {X}_{1} {K}_{3} + {X}_{2} {K}_{4} ]} .$$
